(19) United States
(12) Patent Application Publication
(10) Pub. No.: US 2019/0048980 A1
(43) Pub. Date: Feb. 14, 2019

(54) Linear Pull-Out Unit

(71) Applicant: Josef Muser, Neu-Seiersberg (AT)

(72) Inventor: Josef Muser, Neu-Seiersberg (AT)

(21) Appl. No.: 16/103,029

(22) Filed: Aug. 14, 2018

(30) Foreign Application Priority Data
Aug. 14, 2017 (AT) A 50673/2017

(51) Int. Cl. F16H 19/06; B25J 9/02; B25J 9/00

(52) U.S. Cl. CPC F16H 19/0663; F16H 2019/0686; B25J 9/003; B25J 9/02

(57) ABSTRACT

The invention relates a linear pull-out unit (1), in particular for a robot (5), having at least one telescopic pull-out (5), which has at least one guide rail (2, 3) and at least one lift truck (4, 5, 6), wherein the guide rail (2; 3) and the lift truck (4, 5; 6) are displaceably arranged relative to one another in a direction of displacement (x).

In order to achieve long stroke lengths with the shortest possible overall length, while ensuring precise and reliable guidance and enabling low-failure operation, the telescopic pull-out (5) is designed in three stages, wherein the first stage (9) has a first guide rail (2), the second stage (10) a second guide rail (3) and the third stage (11) a third lift truck (6).

The invention relates to a linear pull-out unit, in particular for a robot, having at least one telescopic pull-out, which has at least one guide rail and at least one lift truck, wherein the guide rail and the lift truck are arranged displaceably relative to one another in a displacement direction.

Linear pull-out units usually have lift trucks with ball or roller bearing elements.

From the AT 505 757 B1, a manipulation device for loading and unloading a shelf with a telescopic pull-out having a lift truck is known, which has a first telescopic part and a second telescopic part. The first telescopic part is connected to the lift truck and the second telescopic part is connected to the first telescopic part in a substantially horizontal direction of movement. The lift truck has a roller bearing unit and a support roller spaced therefrom.

From WO 03/040021 A1 a device for the transverse movement of a load handling device in an overhead system for operating storage units is known, which consists of a horizontally displaceable platform on which telescopically interlocking thrust elements are designed such that in a first state there is an overall size which essentially corresponds to the overall size of the largest thrust element. When extended, the thrust elements protrude significantly beyond one side of the platform.

From the DE 100 65 084 A1, a telescopic conveyor for horizontal handling of loads is known, which has a base profile and a middle profile, which consist of low-cost molded profiles.

EP 1 431 237 A1 describes a load-bearing frame for a storage and retrieval machine having a supporting frame which can be attached to a lifting carriage of the conveyor and supporting devices arranged parallel to one another on said frame with movable telescopic supporting arms for receiving a loading aid, such as pallet, box, etc. Furthermore, the load-bearing frame has a conveying device extending parallel to the direction of adjustment of the supporting devices, which is formed by two conveying devices, each comprising two linear conveyors symmetrically arranged with respect to a central plane extending between the supporting devices perpendicular to a contact surface of the storage and retrieval machine, which form a conveying direction parallel to a direction of adjustment of the supporting devices. The center distances of the linear conveyors extending perpendicular to the central plane are greater than a center distance of the supporting devices.

Known manipulation devices are designed as two- to three-stage telescopes, which are guided via rollers. Rollers can be mounted with very large bearing spacings, as they can also leave their guide groove. In order to guarantee the required rigidity and reduce the play of the pull-outs, it was previously necessary with much effort to mill grooved tracks with exact tolerances. When used in machining centers, there is also the problem that an extremely large number of metal chips are produced, which is why complex special scraper systems are required.

From the field of machine tools it is known to use profile rail rolling bearing guides, which are less susceptible to contamination by metal chips.

From DE 43 31 511 C2, a profile rail recirculating ball bearing guide is known with a carriage which, with guide legs, grips a guide rail provided with a widened head on opposite sides and from above, wherein the carriage is guided in a linearly movable manner via balls arranged between the guide legs and the guide rail.

DE 33 38 751 A1 describes a linear rolling bearing which is suitable for guiding a reciprocating movement at high speed. The linear rolling bearing comprises a bearing cage made of a light material, for example synthetic resin or aluminum.

Furthermore, a linear drive unit with a first machine part and a second machine part is known from DE 103 12 008 A1, wherein a first linear rolling bearing is arranged between the machine parts. A first guide carriage of the first linear rolling bearing is mounted on a first rack rail, wherein a first drive pinion meshes with the first rack rail.

Three-stage telescopic pull-outs with guide carriages would be lowered from linear guide rails if the telescopic support lengths were used and would return to the rail during reverse travel. However, this is not feasible with conventional linear technology and would lead to destruction after a short time. Known triple pull-outs are therefore not designed with linear rollers/ball rails, but with heavy-duty rollers.

It is the object of the invention to realize long stroke lengths with the shortest possible overall length, while ensuring precise and reliable guidance and enabling low-failure operation.

According to the invention, this object is achieved by a linear pull-out unit mentioned above, in which the telescopic pull-out is designed with three stages, wherein the first stage has a first guide rail, the second stage a second guide rail and the third stage a third lift truck.

It is preferably provided that a first lift truck is mounted displaceably in or on the first guide rail, wherein preferably the first lift truck can be firmly connected to a housing or a robot. In addition, it is provided in one embodiment of the invention that a second lift truck rigidly fixed to the second guide rail is displaceably mounted in or on the first guide rail, preferably on a longitudinal side of the first guide rail facing away from the first lift truck.

It is particularly advantageous if the second lift truck is firmly connected to a central area of the second guide rail. This makes it possible to extend the telescopic pull-out in a first direction of displacement and in a direction of displacement opposite thereto until the maximum displacement length defined by the three stages is reached.

One embodiment variant of the invention provides that the third lift truck—preferably on a longitudinal side of the second guide rail facing away from the second lift truck—is displaceably mounted in or on the second guide rail.

It is provided in an advantageous embodiment of the invention that the first guide rail has a first pulling means which is firmly connected on the one hand to the first lift truck and on the other hand—preferably via a first driver part—to the second guide rail. Preferably, the first pulling means has two ends, wherein at least one of the ends is connected to a first clamping device located in or on the first lift truck.

Another advantageous embodiment of the invention provides that the second guide rail has a second pulling means, which is firmly connected to the first guide rail on the one hand—preferably via a second driver part—and to the third lift truck on the other. Preferably, the second pulling means has two ends, at least one of which is connected to a second clamping device located in or on the third lift truck.

In a space-saving and simple design of the invention, it is provided that the pull-out unit has a telescopic pull-out, wherein preferably the third lift truck of the telescopic pull-out is connected to a manipulation device. This variant requires only one actuating device as a drive, which acts on the only first guide rail.

Another advantageous embodiment of the invention provides that the pull-out unit has at least two telescopic pull-outs, wherein the telescopic pull-outs are preferably arranged symmetrically to a plane of symmetry formed parallel to the direction of displacement.

One of the pull-out units has at least two telescopic pull-outs, wherein the telescopic pull-outs are preferably arranged symmetrically to a plane of symmetry formed parallel to the direction of displacement. The third lift trucks of the two telescopic pull-outs are preferably connected to a manipulation device, wherein the manipulation device is preferably arranged in the area of the plane of symmetry between the third lift trucks. This variant allows precise guidance even with relatively high forces and/or heavy loads. In this case, an actuating device preferably acts on each first guide rail in order to enable parallel guidance and uniform pull-out of the pull-out unit without the risk of tilting.

The manipulation device can, for example, be formed by a platform, a gripper or other handling element.

The invention is explained in more detail below on the basis of the exemplary embodiments shown in the drawings, which are not restrictive, wherein:

FIG. 1 shows a pull-out unit according to the invention in an angled view in an extended position;

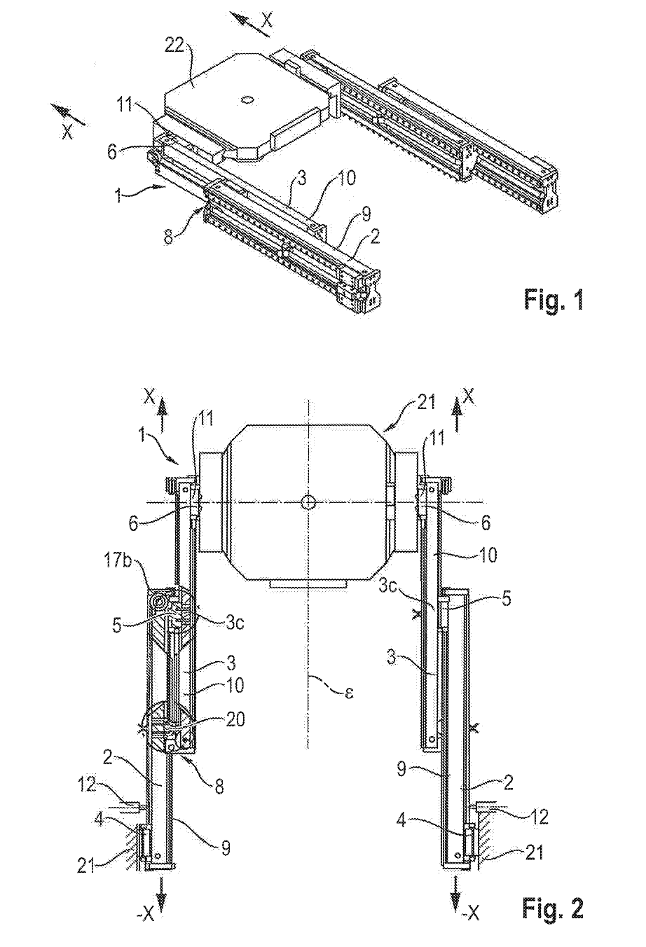

FIG. 2 shows this pull-out unit in a plan view;

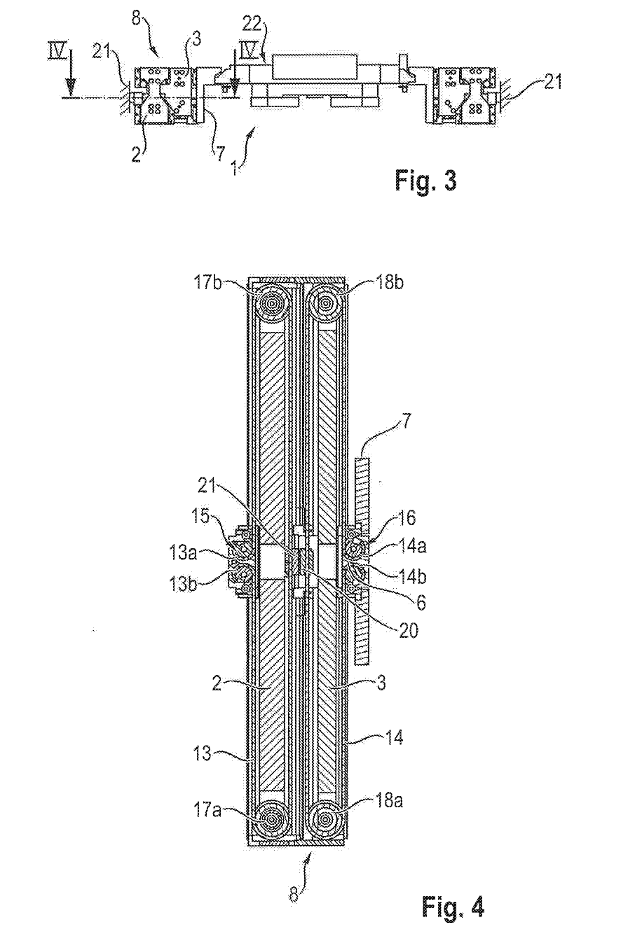

FIG. 3 shows this pull-out unit in a front view;

FIG. 4 shows this pull-out unit in a section according to the line IV-IV in FIG. 3 in a retracted position; and

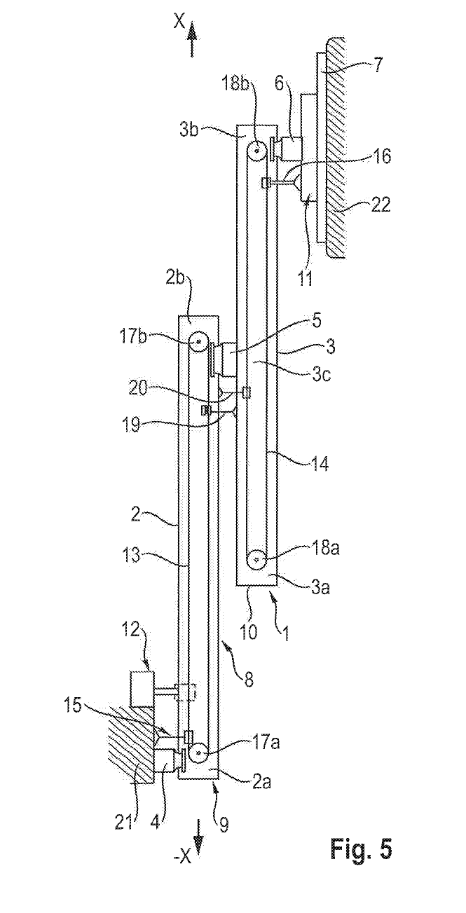

FIG. 5 shows the pull-out unit in a schematic view in an end position.

FIG. 1 to FIG. 4 each show a linear pull-out unit 1 with a first guide rail 2 and a second guide rail 3, wherein the guide rails 2, 3 are connected to one another in a telescopically linearly displaceable manner via lift trucks 1, 6, 5 and are mounted against one another via bearing devices not shown in further detail. The first guide rail 2 has at least one first lift truck 1, which is connected to a robot indicated by reference numeral 20, for example a robot arm.

The first guide rail 2 is movably connected to the first lift truck 4, wherein the first guide rail 2 is guided on the first lift truck 4, or the first lift truck 4 on the first guide rail 2, so that the first guide rail 2 is displaceable relative to the first lift truck 4 in the direction of displacement x. The second guide rail 3 is displaceably connected—also in the direction of displacement x—to the first guide rail 2 by means of a second lift truck 5, wherein the second lift truck 5 is arranged on the second guide rail 3 in an approximately central region 3c—relative to the longitudinal extension of the guide rail 3 in the direction of displacement x—and is firmly connected thereto. Due to the central arrangement of the second lift truck 5, the telescopic pull-out 8 can be moved in the direction of displacement x as well as in the opposite direction. The second lift truck 5 is mounted in a sliding or rolling manner on the first guide rail 2. On the side facing away from the first guide rail 2 or the first lift truck 4, a third lift truck 6, which can be moved in or against the direction of displacement x, −x, is displaceably connected to the second guide rail 3. The third lift truck 6 can be used to connect a manipulation device 21, such as a pallet table, a gripper device or similar manipulation devices, via a mounting plate 7. The bearings between the first lift truck 4 and the first guide rail 2, between the second lift truck 5 and the first guide rail 2, and between the third lift truck 6 and the second guide rail 3 can occur, for example, via conventional roller or ball bearings, wherein for the first lift truck 4, the second lift truck 5 and the third lift truck 6, at least one conventional ball and/or roller carriage can also be used. It is also possible to use two ball or roller carriages for the first lift truck 4, the second lift truck 5 and the third lift truck 6.

The first guide rail 2, the second guide rail 3 and the third lift truck 6 form a three-stage telescopic pull-out 8, wherein the first stage 9 is formed by the first guide rail 2, the second stage 10 by the second guide rail 3 and the third stage 11 by the third lift truck 6.

The telescopic pull-out 8 is driven by means of an actuating device 12 acting on the first guide rail 2, for example an electric motor which acts on the first guide rail 2 via a pinion meshing with a rack, wherein the rack is firmly connected to the first guide rail 2 and the electric motor is firmly connected to the first lift truck 4. The first guide rail 2 has a first pulling means 13 and the second guide rail 3 has a second pulling means 14. The pulling means 13, 14 can be, for example, toothed belts, chains or ropes. The pulling means 13, 14 can be designed as endless devices or comprise ends 13a, 13b; 14a, 14b clamped in a clamping device 15, 16, for example. The pulling means 13, 14 are deflected by rollers 17a, 17b; 18a, 18b mounted rotatably in the region of the rail ends 2a, 2b; 3a, 3b of the respective guide rails 2, 3.

In FIG. 1, FIG. 2 and FIG. 5, the pull-out unit 1 is shown in an extended position and in FIG. 4 in a retracted position.

As can be seen in FIG. 5 in particular, the first pulling means 13 is firmly connected to the first lift truck 4 or the robot 21 via the first clamping device 15 on the one hand and to the second guide rail 3 via a first driver part 19 on the other. The second pulling means 14 is firmly connected on the one hand to the first guide rail 2 via a second driver part 20 and on the other hand to the third lift truck 6 via the second clamping device 16. These “fixed” connections can be made by clamping or form-fitting connections of the driver parts 19, 20.

If the first guide rail 2 is moved by the actuating device 12 in the direction of displacement x or in opposite direction thereto, the first pulling means 13, which is firmly connected to the first lift truck 4, is rolled off, causing the second guide rail 3, which is connected to the first pulling means 13, to move twice as fast as the first guide rail 2 in the direction x or in opposite direction −x. The movement of the second guide rail 3 also causes the second pulling means 14, which is firmly connected to the first guide rail 2 via the second driver part 20, to roll off, causing the third lift truck 6 connected to the second pulling means 14 to move twice as fast as the second guide rail 3 in the direction x or in the opposite direction.

With the described linear pull-out unit 1, high stroke lengths can be achieved with a very small overall length.

1. A linear pull-out unit (1), in particular for a robot (21), having at least one telescopic pull-out (5) which has at least one guide rail (2, 3) and at least one lift truck (4, 5, 6), wherein the guide rail (2; 3) and the lift truck (4, 5; 6) are arranged displaceably relative to one another at least in one direction of displacement (x), characterized in that the telescopic pull-out (5) is designed in three stages, wherein the first stage (9) has a first guide rail (2), the second stage (10) a second guide rail (3) and the third stage (11) a third lift truck (6).

2. The pull-out unit (1) according to claim 1, wherein a first lift truck (4) is mounted displaceably in or on the first guide rail (2), wherein preferably the first lift truck (4) is firmly connectable to a housing or a robot (5).

3. The pull-out unit (1) according to claim 1, wherein a second lift truck (5) firmly connected to the second guide rail (3) is displaceably mounted in or on the first guide rail (2), preferably on a longitudinal side of the first guide rail (2) facing away from the first lift truck (4).

4. The pull-out unit (1) according to claim 3, wherein the second lift truck (4) is firmly connected to a central region (3c) of the second guide rail (3).

5. The pull-out unit (1) according to claim 1, wherein the third lift truck (6)—preferably on a longitudinal side of the second guide rail (3) facing away from the second lift truck (5)—is displaceably mounted in or on the second guide rail (3).

6. The pull-out unit (1) according to claim 1, wherein the first guide rail (2) has a first pulling means (13) which is firmly connected to the first lift truck (4) on the one hand and to the second guide rail (3) on the other hand, preferably via a first driver part (19).

7. The pull-out unit (1) according to claim 6, wherein the first pulling means (13) has two ends (13a, 13b), wherein at least one of the ends (13a; 13b) is connected to a first clamping device (15) arranged in or on the first lift truck (4).

8. The pull-out unit (1) according to claim 1, wherein the second guide rail (3) has a second pulling means (14) which is firmly connected—preferably via a second driver part (20)—to the first guide rail (2) on the one hand and to the third lift truck (6) on the other.

9. The pull-out unit (1) according to claim 8, wherein the second pulling means (14) has two ends (14a, 14b), wherein at least one of the ends (14a; 14b) is connected to a second clamping device (16) arranged in or on the third lift truck (6).

10. The pull-out unit (1) according to claim 1, wherein the pull-out unit (1) has a telescopic pull-out (8), wherein preferably the third lift truck (6) of the telescopic pull-out (8) is connected to a manipulation device (22).

11. The pull-out unit (1) according to claim 1, wherein the pull-out unit (1) has at least two telescopic pull-outs (8), wherein preferably the telescopic pull-outs (8) are arranged symmetrically to a plane of symmetry (E) formed parallel to the direction of displacement (x).

12. The pull-out unit (1) according to claim 11, wherein the third lift trucks (6) of the telescopic pull-outs (8) are connected to a manipulation device (22), wherein preferably the manipulation device (22) is arranged in the region of the plane of symmetry (E) between the third lift trucks (6).

13. The pull-out unit (1) according to claim 10, wherein the manipulation device (22) is formed by a pallet table, a gripper or the like.
